(19) United States
(12) Patent Application Publication
(10) Pub. No.: US 2014/0302405 A1
(43) Pub. Date: Oct. 9, 2014

(54) LITHIUM ION SECONDARY BATTERY

(71) Applicant: NEC Corporation, Tokyo (JP)

(72) Inventors: Hideaki Sasaki, Tokyo (JP); Takehiro Noguchi, Tokyo (JP)

(21) Appl. No.: 14/356,720

(22) PCT Filed: Sep. 24, 2012
(86) PCT No.: PCT/JP2012/074368

§ 371 Date: May 7, 2014

(30) Foreign Application Priority Data
Nov. 14, 2011 (JP) 2011-248620

(51) Int. Cl. H01M 10/0567; H01M 4/525; H01M 4/505; H01M 10/0525; H01M 10/0569

(52) U.S. Cl. CPC H01M 10/0567; H01M 10/0525; H01M 10/0569; H01M 4/505; H01M 4/525
USPC 429/341; 429/188

(57) ABSTRACT

An object of the exemplary embodiment is to provide a lithium ion secondary battery using a 5 V class positive electrode, in which generation of gas is reduced. The exemplary embodiment is a lithium ion secondary battery comprising at least a positive electrode and an electrolyte solution. The lithium ion secondary battery is characterized in that the positive electrode contains a positive electrode active material having an operating potential at 4.5 V or more versus lithium metal, and the electrolyte solution contains a cyano group-containing polymer.

### TECHNICAL FIELD

The exemplary embodiment relates to a lithium ion secondary battery.

### BACKGROUND ART

A lithium ion secondary battery has a higher weight capacity density than those of conventional secondary batteries such as an alkaline storage battery, and it can produce high voltage. Therefore, a lithium ion secondary battery is widely employed as a power source for small equipment and is widely used as a power source for mobile devices such as a cellular phone and a notebook personal computer. In recent years, applications to a large-sized battery, which has a large capacity and for which a long life is required, for example, for an electric vehicle (EV) and a power storage field, are expected with the rise of consciousness to the concerns to environmental problems and energy saving besides the small-sized mobile device applications.

At present, in commercially available lithium ion secondary batteries, a material based on LiMO₂ (M is at least one of Co, Ni, and Mn) having a layer structure or LiMn₂O₄ having a Spinel structure is used as a positive electrode active material. A carbon material such as graphite is used as a negative electrode active material. A charge and discharge region of 4.2 V or less is mainly used for the voltage of such a battery.

On the other hand, it is known that a material in which a part of Mn in LiMn₂O₄ is replaced by Ni or the like shows a high charge and discharge region of 4.5 to 4.8 V versus lithium metal. Specifically, in a spinel compound such as LiNi_{0.5}Mm_{1.5}O₄, oxidation-reduction between Mn³⁺ and Mn⁴⁺ is not used, but Mn is present in the state of Mn⁴⁺ and oxidation-reduction between Ni²⁺ and Ni⁴⁺ is used. Therefore, such a compound shows a high operating voltage of 4.5 V or more. Such a material is called a 5 V class active material, and since it can achieve improvement in energy density by increasing voltage, it is expected as a promising positive electrode material.

However, as the potential of the positive electrode increases, there have been such problems in which an electrolyte solution is liable to be oxidatively decomposed to generate gas; a by-product is produced from the decomposition of an electrolyte solution; or metal ions such as Mn and Ni in a positive electrode active material are eluted and deposited on a negative electrode to expedite the degradation of the negative electrode, thereby accelerating the cycle degradation of a battery. Particularly, the generation of gas has been a serious obstacle to practical application that use a 5 V class positive electrode.

As a technique of suppressing cycle degradation of a lithium ion battery and generation of gas, an electrolyte solution has been mixed with several percent of an additive to thereby form a SEI (Solid Electrolyte Interface) film on the surface of an active material. Although this SEI film is an electronic insulator, the film acts to inhibit the reaction of the active material with an electrolyte solution since the film is considered to have lithium ion conductivity. Many such additives form a film on a negative electrode.

There is also proposed a method of reducing side reaction of an electrode with an electrolyte solution by forming a polymer coating layer with an independent phase morphology on the surface of electrode active material particles (Patent Literature 1).

### CITATION LIST

### Patent Literature

Patent Literature 1: JP4489778B

### SUMMARY OF INVENTION

### Technical Problem

As described above, improving cycle characteristics of a battery and suppressing generation of gas have been attempted by forming a SEI film on a negative electrode. However, in the case of a 5 V class positive electrode, since performance degradation is mainly caused by decomposition of the electrolyte solution on a positive electrode, it has sometimes been difficult to obtain sufficient effect from an additive known for conventional 4 V class positive electrodes, which forms a film on a negative electrode. Further, an unreacted additive may react with a 5 V class positive electrode to reduce battery performance.

Therefore, an object of the exemplary embodiment is to provide a lithium ion secondary battery using a 5 V class positive electrode, in which generation of gas is reduced.

### Solution to Problem

The exemplary embodiment is a lithium ion secondary battery comprising at least a positive electrode and an electrolyte solution. The lithium ion secondary battery is characterized in that the positive electrode contains a positive electrode active material having an operating potential at 4.5 V or more versus lithium metal, and the electrolyte solution contains a cyano group-containing polymer.

### Advantageous Effects of Invention

The exemplary embodiment can provide a lithium ion secondary battery using a 5 V class positive electrode, in which generation of gas is reduced.

### BRIEF DESCRIPTION OF DRAWING

FIG. 1 is a sectional view showing a construction example of the secondary battery according to the exemplary embodiment.

### DESCRIPTION OF EMBODIMENTS

As a result of intensive studies on various materials as an additive to be added to an electrolyte solution for reducing generation of gas on a 5 V class positive electrode, the present inventors have found that a cyano group-containing polymer develops a large effect on reducing generation of gas. The reason is assumed to be as follows. That is, a cyano group in a polymer acts on a positive electrode active material to form a film on the surface thereof which prevents decomposition of an electrolyte solution. Since a cyano group-containing polymer has a high dielectric constant, the film has high compatibility with a lithium salt and has excellent lithium ion conductivity. Further, since the film is also an electronic insulator, it has basic properties of a SEI film. Furthermore, since a cyano group has a high oxidation resistance due to its electron-withdrawing properties, the film can be stably present without being decomposed even if it contacts a 5 V class positive electrode. Therefore, it is thought that decomposition of an electrolyte solution on the surface of a 5 V class positive electrode can be suppressed by using an electrolyte solution containing a cyano group-containing polymer.

Note that the effect of the exemplary embodiment is derived from the fact that a film is effectively formed on a 5 V class positive electrode by previously adding a cyano group-containing polymer to an electrolyte solution.

Hereinafter, the exemplary embodiment will be described.

### (Electrolyte Solution)

Any polymer containing a cyano group can be used without particular limitation as a cyano group-containing polymer in the exemplary embodiment, and, for example, a cyanoethylated polymer in which a hydrogen atom of a hydroxy group (—OH) in the polymer is substituted with a cyanoethyl group (—CH₂CH₂CN) can be used. Examples of the cyanoethylated polymer include a cyanoethylated pullulan (also referred to as a cyanoethyl pullulan), a cyanoethylated starch (also referred to as a cyanoethyl starch), a cyanoethylated cellulose (also referred to as a cyanoethyl cellulose), and a cyanoethylated polyvinyl alcohol (also referred to as a cyanoethyl polyvinyl alcohol). These cyanoethylated polymers can be obtained by substituting hydrogen atoms of hydroxy groups in pullulan, starch, cellulose, and polyvinyl alcohol with cyanoethyl groups.

In the cyanoethylated polymer, the ratio of substitution of hydroxy groups of the base polymer with cyanoethyl groups is preferably 40% or more, more preferably 50% or more, further preferably 60% or more, and most preferably 80% or more. When the ratio of substitution is 40% or more, the quality of a film formed is easily improved, and the solubility in a nonaqueous solvent tends to be improved.

Further, the cyano group-containing polymer such as the cyanoethylated polymer preferably has a molecular weight of 10,000 or more and 1,000,000 or less. When the molecular weight is 10,000 or more, a homogeneous and good quality film is easily formed on the surface of a positive electrode active material. Further, when the molecular weight is 1,000,000 or less, the viscosity of an electrolyte solution can be set to a suitable range, and an electrolyte solution excellent in injection properties or ion conductivity can be obtained. Further, a cyano group-containing polymer more preferably has a molecular weight of 20,000 or more and 200,000 or less.

The concentration of the cyano group-containing polymer such as the cyanoethylated polymer in an electrolyte solution is preferably 0.01% by mass or more and 20% by mass or less, more preferably 0.5% by mass or more and 15% by mass or less, and further preferably 1% by mass or more and 10% by mass or less. When the content is 0.01% by mass or more, a film is more likely to be sufficiently formed. Further, when the content is 20% by mass or less, the viscosity of an electrolyte solution can be prevented from being excessively high.

When the cyano group-containing polymer is used, it is preferably used after removing impurities with a molecular sieve or the like in order to prevent the change of physical properties of an electrolyte solution due to the influence of impurities. As a molecular sieve, zeolite is preferred, and a lithium-exchanged zeolite is more preferred.

A cyano group-containing polymer has the effect of reducing generation of gas in a 5 V class positive electrode probably because a cyano group in the polymer acts on a positive electrode active material to form a film on the surface of the positive electrode active material to thereby suppress the decomposition of an electrolyte solution. Since the cyano group-containing polymer has a high dielectric constant, it has high compatibility with a lithium salt, so it is permeable to lithium ions. On the other hand, since the cyano group-containing polymer is an electronic insulator, a cyanoethylated polymer itself is considered to have the basic properties as a SEI film. Furthermore, it is estimated that the cyano group acts to increase oxidation resistance of the polymer because it has electron-withdrawing properties, and a film of the polymer can be stably present even if it is exposed to high voltage of a 5 V class positive electrode. Although it is not known in what state the film is present, there may be a possibility that the film is formed in a form in which the surface of the positive electrode active material is coated with the polymer without accompanying chemical change of the polymer itself.

An electrolyte solution can contain a supporting salt (electrolyte) such as a lithium salt and a nonaqueous solvent in addition to the above cyano group-containing polymer.

Examples of the supporting salt include a lithium salt and a lithium imide salt. Examples of the lithium salt include, but not particularly limited to, LiPF₆, LiAsF₆, LiAlCl₄, LiClO₄, LiBF₄, and LiSbF₆. Among these, LiPF₆ and LiBF₄ are preferred. Examples of the lithium imide salt include LiN(CₖF₂ₖ₊₁SO₂)(CₘF₂ₘ₊₁SO₂) (wherein k and m are each independently 1 or 2). The supporting salt may be used alone or may also be used in combination of two or more thereof.

Examples of the nonaqueous solvent which can be used include, but not particularly limited to, organic solvents such as cyclic carbonates, linear carbonates, aliphatic carboxylates, γ-lactones, cyclic ethers, and linear ethers. The nonaqueous solvent may be used alone or may also be used in combination of two or more thereof.

Examples of the cyclic carbonates include propylene carbonate (PC), ethylene carbonate (EC), butylene carbonate (BC), and derivatives thereof (including fluorinated compounds). Generally, since cyclic carbonate has high viscosity, a linear carbonate is mixed for use in order to reduce the viscosity. Examples of the linear carbonates include dimethyl carbonate (DMC), diethyl carbonate (DEC), ethyl methyl carbonate (EMC), dipropyl carbonate (DPC), and derivatives thereof (including fluorinated compounds). Examples of the aliphatic carboxylates include methyl formate, methyl acetate, ethyl propionate, and derivatives thereof (including fluorinated compounds). Examples of the γ-lactones include γ-butyrolactone and derivatives thereof (including fluorinated compounds). Examples of the cyclic ethers include tetrahydrofuran, 2-methyltetrahydrofuran, and derivatives thereof (including fluorinated compounds). Examples of the linear ethers include 1,2-diethoxyethane (DEE), ethoxymethoxyethane (EME), diethyl ether, and derivatives thereof (including fluorinated compounds). Examples of other nonaqueous solvents which can also be used include dimethyl sulfoxide, 1,3-dioxolane, formamide, acetamide, dimethylformamide, dioxolane, acetonitrile, propionitrile, nitromethane, ethyl monoglyme, phosphotriester, trimethoxymethane, dioxolane derivative, sulfolane, methyl sulfolane, 1,3-dimethyl-2-imidazolidinone, 3-methyl-2-oxazolidinone, propylene carbonate derivative, tetrahydrofuran derivative, ethyl ether, 1,3-propane sultone, anisole, N-methyl pyrrolidone, and derivatives thereof (including fluorinated compounds).

Further, in order to form a good quality SEI film on the surface of a negative electrode, an additive may be added to the electrolyte solution. The SEI film acts to suppress reactivity with the electrolyte solution or to facilitate the desolvation reaction accompanying the insertion and elimination of lithium ions to thereby prevent the structural degradation of an active material. Examples of such an additive include propane sultone, vinylene carbonate, and a cyclic disulfonate. The content of the additive in the electrolyte solution is preferably 0.2% to 5%. Note that since the degradation of a secondary battery using a 5 V class positive electrode is substantially influenced by the decomposition of an electrolyte solution at the positive electrode, the improvement effect by a cyano group-containing polymer is remarkably observed in the exemplary embodiment.

Further, in the exemplary embodiment, the electrolyte solution preferably contains a fluorinated solvent. That is, in the exemplary embodiment, a nonaqueous solvent preferably includes a fluorinated solvent. A compound containing a fluorine atom can be used as the fluorinated solvent, and a fluorinated ether represented by the following formula (A) is preferred. The quality of a film formed of a cyano group-containing polymer can be improved by using an electrolyte solution containing the fluorinated ether. This is probably because a decomposition product derived from a solvent is difficult to deposite on the surface of an electrode since the oxidation resistance of a fluorinated ether is high, and a homogeneous film is easily formed since a fluorinated ether tends to easily dissolve a cyano group-containing polymer.

R₁₀₁—O—R₁₀₂ (A)

In the formula (A), R₁₀₁ and R₁₀₂ each independently represent an alkyl group or a fluorine-substituted alkyl group, and at least one of R₁₀₁ and R₁₀₂ is a fluorine-substituted alkyl group.

In R₁₀₁ and R₁₀₂, the number of the carbon atoms of the alkyl group is preferably 1 to 12, more preferably 1 to 8, further preferably 1 to 6, particularly preferably 1 to 4. Moreover, the sum of the number of the carbon atoms of R₁₀₁ and R₁₀₂ is preferably 10 or less. Further, in the formula (A), the alkyl group may be linear, branched, or cyclic, and a linear group is preferred.

At least one of R₁₀₁ and R₁₀₂ is a fluorine-substituted alkyl group. The fluorine-substituted alkyl group represents a substituted alkyl group having a structure in which at least one hydrogen atom in an unsubstituted alkyl group is substituted with a fluorine atom. Further, the fluorine-substituted alkyl group is preferably linear. Further, R₁₀₁ and R₁₀₂ are each independently preferably a fluorine-substituted alkyl group having 1 to 6 carbon atoms, more preferably a fluorine-substituted alkyl group having 1 to 4 carbon atoms.

The fluorinated ether is preferably a compound represented by the following formula (B) in terms of voltage endurance and compatibility with other electrolytes.

Y¹—(CY²Y³)ₙ—CH₂O—CY⁴Y⁵—CY⁶Y⁷—Y⁸ (B)

(In the formula (B), n is 1 to 8; Y¹ to Y⁸ are each independently a fluorine atom or a hydrogen atom, provided that at least one of Y¹ to Y³ is a fluorine atom, and at least one of Y⁴ to Y⁸ is a fluorine atom.).

In the formula (B), when n is 2 or more, Y² and Y³ each may be independent for each carbon atom to which Y² and Y³ are bound.

Further, the fluorinated ether is more preferably represented by the following formula (C) in terms of the viscosity of an electrolyte solution or compatibility with other solvents.

H—(CX¹X²—CX³X⁴)ₙ—CH₂O—CX⁵X⁶—CX⁷X⁸—H (C)

In the formula (C), n is 1, 2, 3, or 4; X¹ to X⁸ are each independently a fluorine atom or a hydrogen atom, provided that at least one of X¹ to X⁴ is a fluorine atom, and at least one of X⁵ to X⁸ is a fluorine atom. When n is 2 or more, X¹ to X⁴ each may be independent for each carbon atom to which X¹ to X⁴ are bound.

In the formula (C), n is preferably 1 or 2, more preferably 1.

Further, in the formula (C), the atomic ratio of fluorine atoms to hydrogen atoms [(total number of fluorine atoms)/(total number of hydrogen atoms)] is preferably 1 or more.

Examples of the fluorinated ether include CF₃OCH₃, CF₃OC₂H₆, F(CF₂)₂OCH₃, F(CF₂)₂OC₂H₅, F(CF₂)₃OCH₃, F(CF₂)₃OC₂H₅, F(CF₂)₄OCH₃, F(CF₂)₄OC₂H₅, F(CF₂)₅OCH₃, F(CF₂)₅OC₂H₅, F(CF₂)₈OCH₃, F(CF₂)₈OC₂H₅, F(CF₂)₉OCH₃, CF₃CH₂OCH₃, CF₃CH₂OCHF₂, CF₃CF₂CH₂OCH₃, CF₃CF₂CH₂OCHF₂, CF₃CF₂CH₂O(CF₂)₂H, CF₃CF₂CH₂O(CF₂)₂F, HCF₂CH₂OCH₃, H(CF₂)₂OCH₂CH₃, H(CF₂)₂OCH₂CF₃, H(CF₂)₂CH₂OCHF₂, H(CF₂)₂CH₂O(CF₂)₂H, H(CF₂)₂CH₂O(CF₂)₃H, H(CF₂)₃CH₂O(CF₂)₂H, (CF₃)₂CHOCH₃, (CF₃)₂CHCF₂OCH₃, CF₃CHFCF₂OCH₃, CF₃CHFCF₂OCH₂CH₃, and CF₃CHFCF₂CH₂OCHF₂.

The content of the fluorinated ether in a nonaqueous solvent is, for example, 1 to 60% by volume. Further, the content of the fluorinated ether in a nonaqueous solvent is preferably 10 to 50% by volume, more preferably 20 to 40% by volume. When the content of the fluorinated ether is 50% by volume or less, dissociation of Li ions in a supporting salt will easily occur, improving the conductivity of the electrolyte solution. Further, when the content of the fluorinated ether is 10% by volume or more, oxidative decomposition of the electrolyte solution on a positive electrode will probably be easily suppressed.

The amount of the nonaqueous solvent is not particularly limited and can be suitably selected in the range where the effect of the present exemplary embodiment is generated. The amount of the nonaqueous solvent based on 100 parts by mass of the electrolyte solution is, for example, 90 parts by mass or more, preferably 95 parts by mass or more, more preferably 98 parts by mass or more, and further preferably 99 parts by mass or more.

### (Positive Electrode Active Material)

The positive electrode in the exemplary embodiment contains a positive electrode active material having an operating potential at 4.5 V or more versus lithium (hereinafter also referred to as a 5 V class active material). That is, the positive electrode active material used in the exemplary embodiment has a charge and discharge region at 4.5 V or more versus lithium metal.

The 5 V Class active material is preferably a lithium-containing composite oxide. Examples of the 5 V class active material made of a lithium-containing composite oxide include a spinel type lithium manganese composite oxide, an olivine type lithium manganese-containing composite oxide, and an inverse spinel type lithium manganese-containing composite oxide.

It is preferred to use a lithium manganese composite oxide represented by the following formula (1) as a positive electrode active material.

Liₐ(MₓMn_{2-x-y}A_{y})(O_{4-w}Z_{w}) (1)

(In the formula (1), 0.4≦x≦1.2, 0≦y, x+y<2, 0≦a≦1.2, and 0≦w≦1; M is at least one selected from Co, Ni, Fe, Cr, and Cu; A is at least one selected from Li, B, Na, Mg, Al, Ti, Si, K, and Ca; and Z is at least one selected from F and Cl.).

In the formula (1), the lithium manganese composite oxide preferably contains only Ni as M. Further, it is more preferred that the lithium manganese composite oxide contain Ni as the main component and further contain at least one selected from Co and Fe. Further, A is preferably at least one selected from B, Mg, Al, and Ti. Z is preferably F. Such a substitution element stabilizes a crystal structure and acts to suppress the degradation of the active material.

The average particle size (D₅₀) of the positive electrode active material is preferably 1 to 50 μm, more preferably 5 to 25 μm. The average particle size (D₅₀) of the positive electrode active material can be measured by a laser diffraction and scattering method (micro-track method).

The 5 V class active material may be a positive electrode active material other than that represented by the above formula (1) as long as it is a positive electrode active material having a charge and discharge region at 4.5 V (vs. Li/Li⁺) or more versus lithium metal. It is thought that the quality and the stability of a film formed on the surface of the positive electrode active material are substantially influenced by the potential thereof, and the film will hardly be affected directly by the composition of the active material.

Other examples of the 5 V class active material which can be used include an olivine-based composite oxide represented by LiₓMPO₄F_{y} (0≦x≦2, 0≦y≦1, and M is at least one selected from Co and Ni); a Si-containing composite oxide represented by LiₓMSiO₄ (0≦x≦2, and M is at least one selected from Mn, Fe, and Co); and a layered composite oxide represented by Liₓ[LiₐM_{b}Mn_{1-a-b}]O₂ (0≦x≦1, 0.02≦a≦0.3, 0.1<b<0.7, and M is at least one selected from Ni, Co, Fe, and Cr).

### (Negative Electrode Active Material)

Examples of the negative electrode active materials which can be used include, but are not particularly limited to, carbon materials such as graphite and amorphous carbon. Graphite is preferably used as a negative electrode active material in terms of energy density. The negative electrode active material may also include, other than carbon materials, materials which form alloys with Li such as Si, Sn, or Al, Si oxides, Si composite oxides containing Si and other metal elements other than Si, Sn oxides, Sn composite oxides containing Sn and other metal elements other than Sn, Li₄Ti₅O₁₂, and composite materials in which these materials are covered with carbon. The negative electrode active material may be used alone or may be used in combination of two or more thereof.

### (Electrode)

The positive electrode includes a positive electrode active material layer formed on at least one surface of a positive electrode current collector. The positive active material layer comprises a positive electrode active material which is the main material, a binder, and a conductive aid. The negative electrode includes a negative electrode active material layer formed on at least one surface of a negative electrode current collector. The negative active material layer comprises a negative electrode active material which is the main material, a binder, and a conductive aid.

Examples of the binder used in the positive electrode include polyvinylidene fluoride (PVDF) and an acrylic polymer. Examples of the binder used in the negative electrode include a styrene-butadiene rubber (SBR) in addition to the above materials. When an aqueous binder such as an SBR emulsion is used, a thickener such as carboxymethyl cellulose (CMC) can also be used.

Carbon materials such as carbon black, granular graphite, flake graphite, and carbon fiber can be used as the conductive aid for both the positive electrode and the negative electrode. In particular, it is preferred to use carbon black having low crystallinity in the positive electrode.

As the positive electrode current collector, for example, aluminum, stainless steel, nickel, titanium, or alloys thereof can be used. As the negative electrode current collector, for example, copper, stainless steel, nickel, titanium, or alloys thereof can be used.

The electrode can be obtained, for example, by dispersing and kneading an active material, a binder, and a conductive aid in a solvent such as N-methyl-2-pyrrolidone (NMP) in a predetermined blending amount to prepare a slurry and applying the slurry to the current collector to form the active material layer. The obtained electrode can also be compressed by a method such as a roll press to be adjusted to a suitable density.

### (Separator)

Examples of a separator which can be used include, but are not particularly limited to, a porous film made of a polyolefin such as polypropylene and polyethylene, a fluororesin, and the like, cellulose, and an inorganic separator made of glass and the like.

### (Outer Packaging Body)

As an outer packaging body, for example, a can such as a coin type can, a square type can, and a cylinder type can, and a laminated outer packaging body can be used; and a laminated outer packaging body prepared by using a flexible film made of a laminate of a synthetic resin and metal foil is preferred in terms of allowing reduction in weight and achieving an improvement in battery energy density. Since the laminate type battery is also excellent in heat dissipation, it is suitably used as a battery for vehicles such as an electric vehicle.

In the case of a laminate type secondary battery, examples of laminate films which can be used as the outer packaging body include an aluminum laminate film, a stainless steel laminate film, and a silica-coated laminate film of polypropylene, polyethylene, and the like. In particular, an aluminum laminate film is preferably used in terms of suppressing volume expansion and in terms of cost.

### (Battery Construction)

The construction of the secondary battery according to the exemplary embodiment is not particularly limited, and can be a construction, for example, where an electrode element in which a positive electrode and a negative electrode are oppositely disposed and an electrolyte solution are enclosed in an outer packaging body. Examples of the shape of the secondary battery include, but are not particularly limited to, a cylindrical type, a flat wound rectangular type, a stacked rectangular type, a coin type, a flat wound laminate type, and a stacked laminate type.

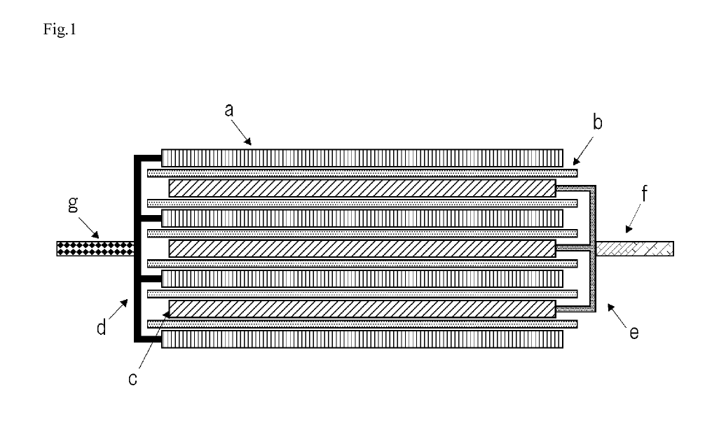

Hereinafter, a stacked laminate type secondary battery is described as an example. FIG. 1 is a schematic sectional view showing a structure of an electrode element in a stacked type secondary battery using a laminate film for an outer packaging body. This electrode element is formed by alternately stacking plural positive electrodes c and plural negative electrodes a with a separator b placed therebetween. A positive electrode collector e in each positive electrode c is electrically connected by being welded to each other at the end part thereof which is not covered with a positive electrode active material, and further a positive electrode terminal f is welded to the welded part. A negative electrode collector d in each negative electrode a is electrically connected by being welded to each other at the end part thereof which is not covered with a negative electrode active material, and further a negative electrode terminal g is welded to the welded part.

Since an electrode element having such a planar stacked structure has no portion of a small R (such as a region near a winding core of a wound structure and a turn region of a flat wound structure), there is an advantage that it is less adversely affected by volume change of the electrode with the charge and discharge cycle than in the case of an electrode element having a wound structure.

### EXAMPLES

Examples of the exemplary embodiment will be described in detail below, but the exemplary embodiment is not limited only to the following examples.

### Example 1

### (Preparation of Negative Electrode)

A negative electrode slurry was prepared by uniformly dispersing, in NMP, artificial graphite powder (average particle size (D₅₀): 20 μm, specific surface area: 1.2 m²/g) as a negative electrode active material and PVDF as a binder in a weight ratio of 95:5. The negative electrode slurry was applied to copper foil having a thickness of 15 μm used as a negative electrode current collector, followed by drying at 125° C. for 10 minutes to allow NMP to evaporate to thereby form a negative electrode active material layer, which was then pressed to prepare a negative electrode. Note that the weight of the negative electrode active material layer per unit area after drying was set to 0.008 g/cm².

### (Preparation of Positive Electrode)

A positive electrode slurry was prepared by uniformly dispersing, in NMP, LiNi_{0.5}Mn_{1.5}O₄ powder (average particle size (D₅₀): 10 μm, specific surface area: 0.5 m²/g) as a positive electrode active material, PVDF as a binder, and carbon black as a conductive aid, in a weight ratio of 93:4:3. The positive electrode slurry was applied to aluminum foil having a thickness of 20 μm used as a positive electrode current collector, followed by drying at 125° C. for 10 minutes to allow NMP to evaporate to thereby prepare a positive electrode. Note that the weight of the positive electrode active material layer per unit area after drying was set to 0.018 g/cm².

### (Electrolyte Solution)

In a nonaqueous solvent in which EC and DMC are mixed in a ratio of EC:DMC=40:60 (volume ratio), LiPF₆ was dissolved in a concentration of 1 mol/L as a supporting salt (electrolyte) to prepare an electrolytic solution. In the electrolytic solution, a cyanoethylated starch (trade name; VISGUM 12, having a ratio of substitution of 83%, manufactured by Nippon Starch Chemical Co., Ltd.) was dissolved in a concentration of 1% by mass to prepare an electrolyte solution.

### (Preparation of Laminate Type Battery)

The positive electrode and the negative electrode prepared as described above were respectively cut into a size of 5 cm×6.0 cm, in which a portion of 5 cm×1 cm in size on an edge was a portion where the electrode active material layer was not formed (uncoated portion) for connecting a tab, and a portion where the electrode active material layer was formed had a size of 5 cm×5 cm. A positive electrode tab made from aluminum having a size of 5 mm in width×3 cm in length×0.1 mm in thickness was ultrasonically welded to the uncoated portion of the positive electrode by 1 cm in length. Similarly, a negative electrode tab made from nickel having the same size as the positive electrode tab was ultrasonically welded to the uncoated portion of the negative electrode. The above negative electrode and positive electrode were arranged on both sides of a separator comprising polyethylene and polypropylene and having a size of 6 cm×6 cm so that the electrode active material layers might overlap with each other with the separator in between, thus obtaining an electrode laminate. Three edges of two aluminum laminate films each having a size of 7 cm×10 cm were heat-sealed at a width of 5 mm except one of the longer edges thereof to adhere the three edges to prepare a bag-shaped laminated outer packaging body. The above electrode laminate was inserted into the laminated outer packaging body so that the electrode laminate might be positioned 1 cm away from one of the shorter edges of the laminated outer packaging body. The laminate type battery was prepared by pouring 0.2 g of the above electrolyte solution, allowing the electrode laminate to be vacuum impregnated with the nonaqueous electrolyte solution, and then heat-sealing the opening under reduced pressure to seal the opening at a width of 5 mm

### (First Charge and Discharge)

The laminate type battery prepared as described above was charged at a 12-mA constant current corresponding to 5 hour rate (0.2 C) to 4.8 V at 20° C., subjected to a 4.8 V constant-voltage charge for 8 hours in total, and then subjected to a constant-current discharge at 60 mA corresponding to 1 hour rate (1 C) to 3.0 V.

### (Cycle Test)

The laminate type battery having undergone a charge and discharge cycle for the first time was charged at 1 C to 4.8 V, subjected to a 4.8 V constant-voltage charge for 2.5 hours in total, and then subjected to a constant-current discharge at 1 C to 3.0 V. These charge and discharge were defined as one charge and discharge cycle. The charge and discharge cycle was repeated 200 times at 45° C. The ratio of the discharge capacity after 200 cycles to the first discharge capacity was calculated as a capacity retention rate (%). Further, the cell volume after the first charge and discharge was subtracted from the cell volume after the cycles to determine the amount of volume change (cc). The volume was measured using the Archimedes method from the difference between the weight in water and the weight in air.

### Example 2

A battery was prepared and evaluated in the same manner as in Example 1 except that the concentration of the cyanoethylated starch was changed to 3% by mass.

### Example 3

A battery was prepared and evaluated in the same manner as in Example 1 except that the concentration of the cyanoethylated starch was changed to 4% by mass.

### Example 4

A battery was prepared and evaluated in the same manner as in Example 1 except that the concentration of the cyanoethylated starch was changed to 5% by mass.

### Example 5

A battery was prepared and evaluated in the same manner as in Example 1 except that the concentration of the cyanoethylated starch was changed to 7% by mass.

### Example 6

A battery was prepared and evaluated in the same manner as in Example 1 except that the concentration of the cyanoethylated starch was changed to 10% by mass.

### Example 7

A battery was prepared and evaluated in the same manner as in Example 2 except that a cyanoethylated pullulan (trade name; Cyanoresin CR-S, having a ratio of substitution of 81%, manufactured by Shin-Etsu Chemical Co., Ltd.) was used instead of the cyanoethylated starch. The cyanoethylated pullulan has a molecular weight of about 200,000.

### Example 8

A battery was prepared and evaluated in the same manner as in Example 4 except that a cyanoethylated pullulan (trade name; Cyanoresin CR-S, having a ratio of substitution of 81%, manufactured by Shin-Etsu Chemical Co., Ltd.) was used instead of the cyanoethylated starch.

### Example 9

A battery was prepared and evaluated in the same manner as in Example 2 except that a cyanoethylated polyvinyl alcohol (trade name; Cyanoresin CR-V, having a ratio of substitution of 90%, manufactured by Shin-Etsu Chemical Co., Ltd.) was used instead of the cyanoethylated starch.

### Example 10

A battery was prepared and evaluated in the same manner as in Example 2 except that a cyanoethylated cellulose (having a ratio of substitution of 47%, manufactured by Tokyo Chemical Industry Co., Ltd.) was used instead of the cyanoethylated starch.

### Example 11

A nonaqueous solvent was prepared by mixing EC, DMC, and a fluorinated ether (FE) represented by H(CF₂)₂CH₂OCF₂CF₂H as a fluorinated solvent in a ratio of EC:DMC:FE=40:40:20 (volume ratio). LiPF₆ was dissolved in the nonaqueous solvent in a concentration of 1 mol/L as a supporting salt (electrolyte) to prepare an electrolytic solution (containing FE). A battery was prepared and evaluated in the same manner as in Example 4 except that an electrolyte solution was prepared using the electrolytic solution (containing FE).

### Comparative Example 1

A battery was prepared and evaluated in the same manner as in Example 1 except that the above electrolytic solution was used as an electrolyte solution (containing no cyanoethylated polymer).

### Comparative Example 2

A battery was prepared and evaluated in the same manner as in Example 11 except that the above electrolytic solution (containing FE) was used as an electrolyte solution (containing no cyanoethylated polymer).

### (Results)

Table 1 shows the measurement results of the amount of volume change and the capacity retention rate after 200 cycles at 45° C. in Examples 1 to 11 and Comparative Examples 1 to 2. Here, the amount of volume change shows the amount of gas generated in a cell.

The amount of gas generated was smaller in Examples 1 to 6 in which the cyanoethylated starch was added in the range of 1 to 10% by mass than that in Comparative Example 1 in which the cyanoethylated starch was not added. In the case of the cyanoethylated starch, the generation of gas was reduced most when 5% by mass of the cyanoethylated starch was added.

When 5% by mass or more of the cyanoethylated starch was added, the capacity retention rate was a little reduced, which is probably caused by the viscosity increase of the electrolyte solution, and it is expected that its influence will differ depending on the type of cyano group-containing polymers.

Also in the case of Examples 7 and 8 in which the cyanoethylated pullulan was used, the effect of suppressing generation of gas was similarly observed, and the amount of gas generated when 5% by mass of the cyanoethylated pullulan was added (Example 8) was reduced to about one fourth of the amount of gas generated in Comparative Examples. The amount of gas generated was similarly reduced in the cases of the cyanoethylated polyvinyl alcohol (PVA) in Example 9 and the cyanoethylated cellulose in Example 10. When cyanoethylated polymers are added in an amount of 3% by mass, the amount of gas generated in a system containing the cyanoethylated polyvinyl alcohol and a system containing the cyanoethylated cellulose was smaller than that in a system containing the cyanoethylated starch and a system containing the cyanoethylated pullulan. This has shown that the influence on the amount of gas generated differs also depending on the type of cyanoethylated polymers.

It was verified from Example 11 and Comparative Example 2 that when a fluorinated ether which is a kind of a fluorinated solvent was mixed with an electrolyte solution, the effect of suppressing generation of gas was further improved.

The above results have shown that the amount of gas generated after the cycle test is reduced by adding a cyanoethylated polymer. The amount thereof to be added is preferably adjusted depending on the type of cyano group-containing polymers, and, specifically, the amount is preferably in the range of 1 to 10% by mass, more preferably in the range of 3 to 7% by mass.

TABLE 1

| | | | Amount of | |
|---|---|---|---|---|
| | | Concentration, | volume change | Capacity retention |
| | Additive | mass % | (cc) | rate (%) |
| Example 1 | Cyanoethylated starch | 1 | 0.70 | 61 |
| Example 2 | Cyanoethylated starch | 3 | 0.59 | 62 |
| Example 3 | Cyanoethylated starch | 4 | 0.41 | 58 |
| Example 4 | Cyanoethylated starch | 5 | 0.23 | 56 |
| Example 5 | Cyanoethylated starch | 7 | 0.44 | 55 |
| Example 6 | Cyanoethylated starch | 10 | 0.59 | 55 |
| Example 7 | Cyanoethylated pullulan | 3 | 0.62 | 59 |
| Example 8 | Cyanoethylated pullulan | 5 | 0.20 | 56 |
| Example 9 | Cyanoethylated PVA | 3 | 0.19 | 54 |
| Example 10 | Cyanoethylated cellulose | 3 | 0.39 | 58 |
| Example 11 | Cyanoethylated starch | 5 | 0.17 | 57 |
| Comparative | None | — | 0.78 | 58 |
| Example 1 | | | | |
| Comparative | None | — | 0.62 | 59 |
| Example 2 | | | | |

### (XPS Analysis of Negative Electrode and Positive Electrode)

In order to verify whether a cyanoethylated polymer has formed a film on a positive electrode, quantitative analysis of nitrogen (derived from a cyanoethyl group) on the surface of an electrode was performed using X-ray photoelectron spectroscopy (XPS). The measuring method was as follows. Batteries having the same construction as in Example 4 and Comparative Example 1 were subjected to the first charge and discharge, the battery undergone decomposition, and then the negative electrode and the positive electrode were removed. The removed electrodes were washed with DEC to remove components such as an electrolyte solution that adhered to the electrodes and then dried to obtain measurement samples. The XPS measurement was performed under the following conditions to qualitatively analyze nitrogen from the N₁, peak area ratio.

Apparatus: Quantera SXM manufactured by PHI Inc.

Excited X ray: monochromatic Al Kα_{1,2} ray (1486.6 eV)

X ray diameter: 200 μm

Photoelectron take-off angle: at 45° C. in argon atmosphere

Further, Mn and Ni were qualitatively analyzed at the same time.

The measurement results are shown in Table 2. It was found that, in Example 4, about the same amount of nitrogen was present on the negative electrode and the positive electrode. Therefore, it is suggested that a certain film was also formed on the positive electrode. Although Mn and Ni were observed on the negative electrode in Comparative Example 1, they were below the detection limit in Example 4. This shows that a film formed from a cyanoethylated polymer prevents the elution of Mn and Ni of the positive electrode active material and the deposition of the same on the negative electrode.

TABLE 2

| | Electrode | Nitrogen at. % | Manganese at. % | Nickel at. % |
|---|---|---|---|---|
| Example 4 | Negative electrode | 8.8 | Below detection | Below detection |
| | | | limit | limit |
| | Positive electrode | 6.5 | 1.4 | 0.3 |
| Comparative | Negative electrode | Below detection | 1.7 | 0.4 |
| Example 1 | | limit | | |
| | Positive electrode | Below detection | 3.3 | 0.6 |
| | | limit | | |

According to the results in Table 1, although there is a difference in the influence of additive concentration, the same effect has been obtained irrespective of the difference in polymer skeleton. Consequently, it can be said that the influence of a cyanoethyl group (—CH₂CH₂—CN) in a side chain is dominant. Thus, since a cyano group characterizes the properties of a cyanoethyl group as a functional group, any cyano group-containing polymer containing a cyano group (—CN) will generate the effect of the present invention.

It is thought that the quality of a film formed on the surface of an electrode active material and its stability are substantially influenced by its potential, and direct influence of the composition of the active material will be small. Therefore, the active material is not limited to the positive electrode active material used in the Examples (LiNi_{0.5}Mn_{1.5}O₄), but any active material having an operating potential at 4.5 V (vs. Li/Li⁺) or more versus lithium metal may be used.

Further, since such a film will be similarly formed even if the type of an electrolyte solution is different, a cyanoethylated polymer can be applied to any electrolyte solution irrespective of its type as long as it can dissolve the cyanoethylated polymer. In particular, a cyanoethylated polymer can also be used in an electrolyte solution containing a fluorinated solvent which has high oxidation resistance.

This application claims the priority based on Japanese Patent Application No. 2011-248620 filed on Nov. 14, 2011, the disclosure of which is incorporated herein in its entirety.

Hereinabove, the invention of the present application has been described with reference to exemplary embodiment and Examples, but the invention of the present application is not limited to the above exemplary embodiment and Examples. Various modifications which can be understood by those skilled in the art can be made to the constitution and details of the invention of the present application within the scope of the invention of the present application.

### REFERENCE SIGNS LIST

a negative electrode
b separator
c positive electrode
d negative electrode collector
e positive electrode collector
f positive electrode terminal
g negative electrode terminal

1. A lithium ion secondary battery comprising at least a positive electrode and an electrolyte solution, wherein the positive electrode contains a positive electrode active material having an operating potential at 4.5 V or more versus lithium metal, and the electrolyte solution contains a cyano group-containing polymer.

2. The lithium ion secondary battery according to claim 1, wherein the cyano group-containing polymer is a cyanoethylated polymer in which at least a part of a hydroxy group (—OH) in the polymer is replaced with a cyanoethyl group.

3. The lithium ion secondary battery according to claim 2, wherein the cyanoethylated polymer is at least one selected from a cyanoethylated pullulan, a cyanoethylated starch, a cyanoethylated cellulose, and a cyanoethylated polyvinyl alcohol.

4. The lithium ion secondary battery according to claim 2, wherein a ratio of substitution with a cyanoethyl group in the cyanoethylated polymer is 40% or more.

5. The lithium ion secondary battery according to claim 1, wherein concentration of the cyano group-containing polymer in the electrolyte solution is 1% by mass or more and 10% by mass or less.

6. The lithium ion secondary battery according to claim 1, wherein concentration of the cyano group-containing polymer in the electrolyte solution is 3% by mass or more and 7% by mass or less.

7. The lithium ion secondary battery according to claim 1, wherein the cyano group-containing polymer has a molecular weight of 10,000 or more and 1,000,000 or less.

8. The lithium ion secondary battery according to claim 1, wherein the electrolyte solution further contains a fluorinated solvent.

9. The lithium ion secondary battery according to claim 8, wherein the fluorinated solvent is a fluorinated ether represented by the following formula (A):
R₁₀₁—O—R₁₀₂ (A)
In the formula (A), R₁₀₁ and R₁₀₂ each independently represent an alkyl group or a fluorine-substituted alkyl group, and at least one of R₁₀₁ and R₁₀₂ is a fluorine-substituted alkyl group.

10. The lithium ion secondary battery according to claim 1, wherein the positive electrode active material is represented by the following formula (1):
Liₐ(MₓMn_{2-x-y}A_{y})(O_{4-w}Z_{w}) (1)
wherein 0.4≦x≦1.2, 0≦y, x+y<2, 0≦a≦1.2, and 0≦w≦1; M is at least one selected from Co, Ni, Fe, Cr, and Cu; A is at least one selected from Li, B, Na, Mg, Al, Ti, Si, K, and Ca; and Z is at least one selected from F and Cl.

11. The lithium ion secondary battery according to claim 3, wherein a ratio of substitution with a cyanoethyl group in the cyanoethylated polymer is 40% or more.

12. The lithium ion secondary battery according to claim 3, wherein concentration of the cyano group-containing polymer in the electrolyte solution is 1% by mass or more and 10% by mass or less.

13. The lithium ion secondary battery according to claim 4, wherein concentration of the cyano group-containing polymer in the electrolyte solution is 1% by mass or more and 10% by mass or less.

14. The lithium ion secondary battery according to claim 3, wherein the cyano group-containing polymer has a molecular weight of 10,000 or more and 1,000,000 or less.

15. The lithium ion secondary battery according to claim 12, wherein the cyano group-containing polymer has a molecular weight of 10,000 or more and 1,000,000 or less.

16. The lithium ion secondary battery according to claim 11, wherein the electrolyte solution further contains a fluorinated solvent.

17. The lithium ion secondary battery according to claim 13, wherein the electrolyte solution further contains a fluorinated solvent.

18. The lithium ion secondary battery according to claim 16, wherein the fluorinated solvent is a fluorinated ether represented by the following formula (A):
R₁₀₁—O—R₁₀₂ (A)
In the formula (A), R₁₀₁ and R₁₀₂ each independently represent an alkyl group or a fluorine-substituted alkyl group, and at least one of R₁₀₁ and R₁₀₂ is a fluorine-substituted alkyl group.

19. The lithium ion secondary battery according to claim 17, wherein the fluorinated solvent is a fluorinated ether represented by the following formula (A):
R₁₀₁—O—R₁₀₂ (A)
In the formula (A), R₁₀₁ and R₁₀₂ each independently represent an alkyl group or a fluorine-substituted alkyl group, and at least one of R₁₀₁ and R₁₀₂ is a fluorine-substituted alkyl group.

20. The lithium ion secondary battery according to claim 9, wherein the positive electrode active material is represented by the following formula (1):
Liₐ(MₓMn_{2-x-y}A_{y})(O_{4-w}Z_{w}) (1)
wherein 0.4≦x≦1.2, 0≦y, x+y<2, 0≦a≦1.2, and 0≦w≦1; M is at least one selected from Co, Ni, Fe, Cr, and Cu; A is at least one selected from Li, B, Na, Mg, Al, Ti, Si, K, and Ca; and Z is at least one selected from F and Cl.
